(19) United States
(12) Patent Application Publication
(10) Pub. No.: US 2003/0087687 A1
(43) Pub. Date: May 8, 2003

(54) Slot machine with unified reel symbols

(76) Inventors: David K. Locke, Chicago, IL (US); Larry J. Pacey, Prospect Heights, IL (US); Alexandru V. Vircol, Skokie, IL (US)

Correspondence Address: Michael J. Blankstein, WMS Gaming Inc., 800 South Northpoint Boulevard, Waukegan, IL, 60085, US

(21) Appl. No.: 09/992,392

(22) Filed: Nov. 6, 2001

(51) Int. Cl. A63F 13/00

(52) U.S. Cl. 463/20

(57) ABSTRACT

A slot machine comprises a plurality of mechanical or simulated reels. Each reel bears a plurality of discrete symbols and a continuous graphical element extending between adjacent ones of the discrete symbols such that the discrete symbols are unified by the graphical element. The discrete symbols are superimposed over the graphical element. The reels are rotated and stopped to place a portion of each reel in visual association with a display area. A payout is determined based on the portion of each reel associated with the display area. In an alternative embodiment, the plurality of discrete symbols are replaced with discrete symbol positions, and a discrete symbol on each reel moves between adjacent ones of the discrete symbol positions as the reel is rotated. A payout may be accumulated based on each discrete symbol position traversed by the discrete symbol.

### FIELD OF THE INVENTION

The present invention relates generally to slot machines and, more particularly, to a slot machine including a rotatable reel with discrete reel symbols unified by a continuous graphical element.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator. Accordingly, in the competitive gaming industry, there is a continuing need for slot machine manufacturers to produce new types of games, or enhancements to existing games, which will attract frequent play by enhancing the entertainment value and excitement associated with the game.

### SUMMARY OF THE INVENTION

A slot machine comprises a plurality of mechanical or simulated reels. Each reel bears a plurality of discrete symbols and a continuous graphical element extending between adjacent ones of the discrete symbols such that the discrete symbols are unified by the graphical element. The discrete symbols are superimposed over the graphical element. The reels are rotated and stopped to place a portion of each reel in visual association with a display area. A payout is determined based on the portion of each reel associated with the display area. In an alternative embodiment, the plurality of discrete symbols are replaced with discrete symbol positions, and a discrete symbol on each reel moves between adjacent ones of the discrete symbol positions as the reel is rotated. A payout may be accumulated based on each discrete symbol position traversed by the discrete symbol.

### BRIEF DESCRIPTION OF THE DRAWINGS

The foregoing and other advantages of the invention will become apparent upon reading the following detailed description and upon reference to the drawings in which:

FIG. 1 is an isometric view of a slot machine embodying the present invention;

FIG. 2 is a block diagram of a control system suitable for operating the slot machine;

FIG. 3 is a display screen capture associated with a basic slot game and showing a symbol combination for triggering a bonus game according to a first embodiment;

FIGS. 4, 5, and 6 are display screen captures associated with the bonus game; and

FIG. 7 and 8 are display screen captures associated with a bonus game according to a second embodiment.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

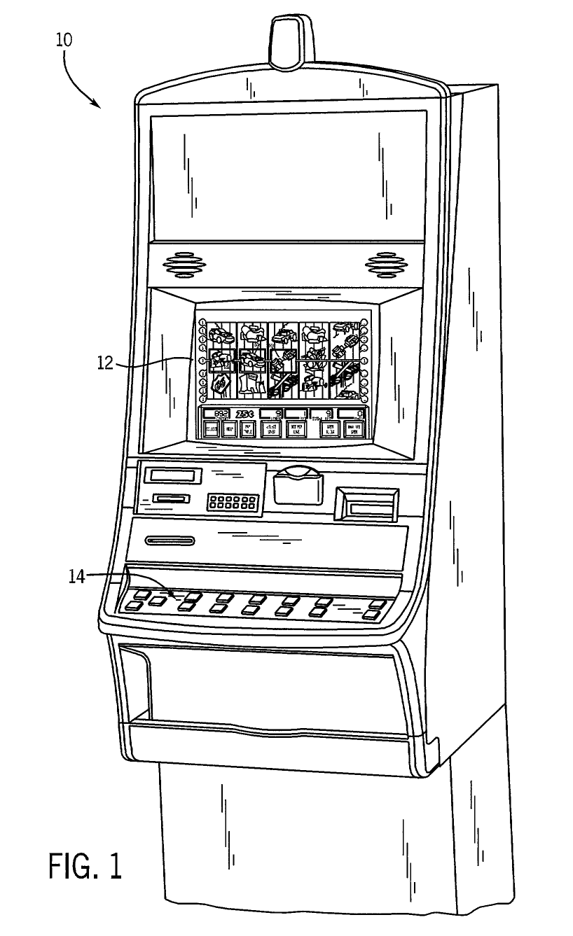

Turning now to the drawings and referring initially to FIG. 1, a slot machine 10 is operable to play a game of chance. The game of chance features a basic slot game with five spinning reels and a bonus game triggered by a start-feature outcome in the basic slot game. The reels are preferably simulated on a video display 12 but may alternatively be physical and driven by respective stepper motors. If the reels are simulated on the video display 12, the display 12 may be outfitted with a touch screen and in the form of a dot matrix, CRT, LED, LCD, electro-luminescent, or other type of video display known in the art. In the illustrated embodiment, the slot machine 10 is an “upright” version in which the display 12 is oriented vertically relative to the player. Alternatively, the slot machine may be a “slant-top” version in which the display 12 is slanted at about a thirty-degree angle toward the player of the slot machine 10.

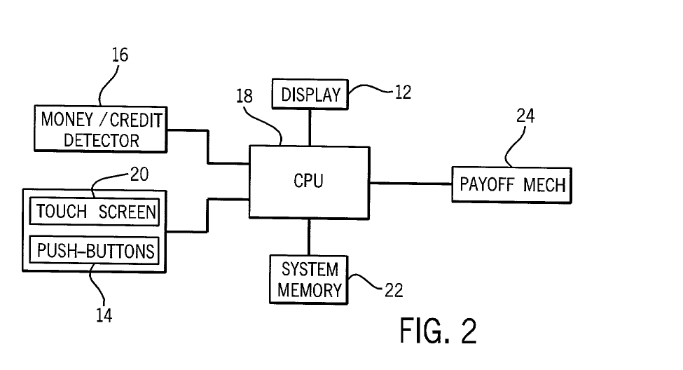

FIG. 2 is a block diagram of a control system suitable for operating the slot machine 10. Money/credit detector 16 signals a central processing unit (“CPU”) 18 when a player has inserted money or played a number of credits. The money may be provided by coins, bills, tickets, coupons, cards, etc. Then, the CPU 18 operates to execute a game program that causes the display 12 to display five simulated symbol-bearing reels. The player may select a number of pay lines to play, an amount to wager, and start game play via the touch screen 20 or the push-buttons 14, causing the CPU 18 to set the reels in motion, randomly select a game outcome, and then stop the reels to display discrete symbols corresponding to the pre-selected game outcome. One or more of the basic game outcomes may trigger a bonus game.

A system memory 22 stores control software, operational instructions and data associated with the slot machine 10. In one embodiment, the system memory 22 comprises a separate read-only memory (ROM) and battery-backed random-access memory (RAM). However, it will be appreciated that the system memory 22 may be implemented on any of several alternative types of memory structures or may be implemented on a single memory structure. A payoff mechanism 24 is operable in response to instructions from the CPU 18 to award a payoff to the player in response to certain winning outcomes that might occur in the basic game or the bonus game. The payoff may be provided in the form of coins, bills, tickets, coupons, cards, etc. The payoff amounts are determined by one or more pay tables stored in the system memory 22.

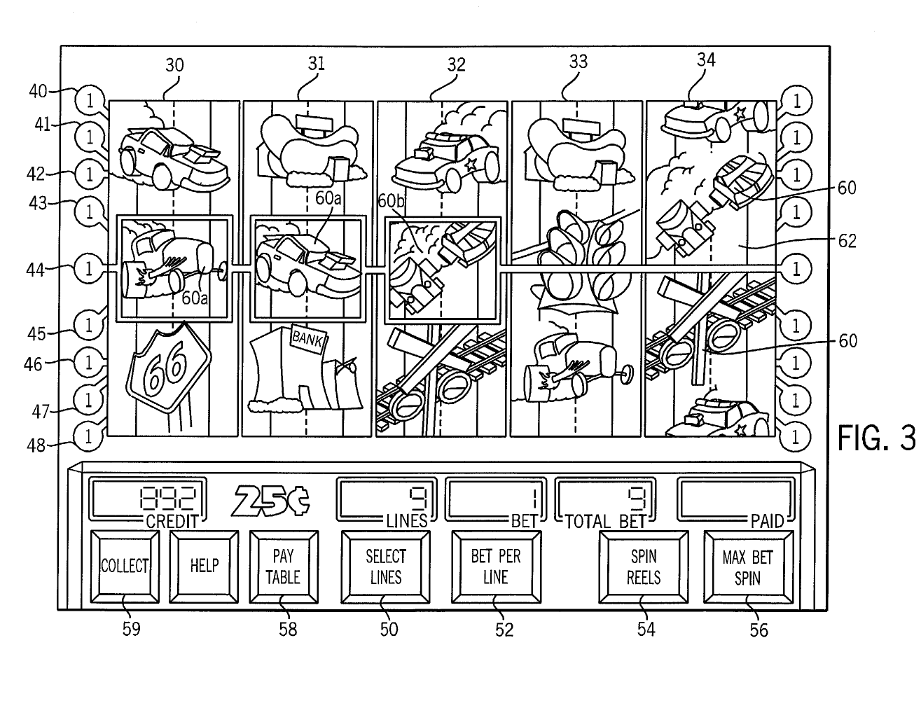

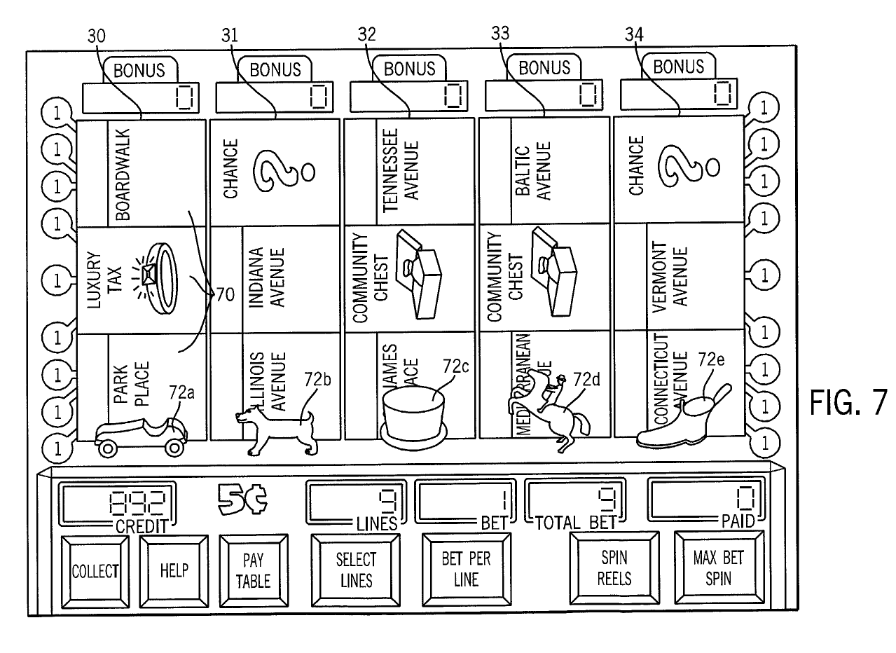

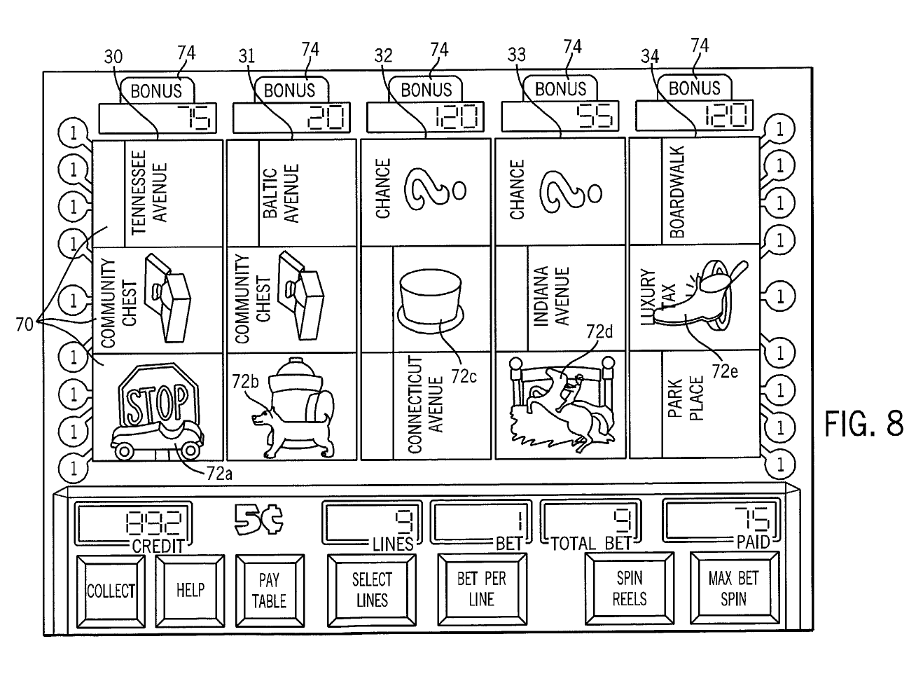

Referring to FIG. 3, the basic game is implemented on the video display 12 on five simulated spinning reels 30-34 with nine pay lines 40-48. The number of reels and the number and configuration of the pay lines may be varied from that shown. Each of the pay lines 40-48 extends through one discrete symbol 60 on each of the five reels 30-34. Each reel bears a plurality of discrete symbols 60 and a continuous graphical element 62 extending between adjacent ones of the discrete symbols 60 such that the discrete symbols 60 are unified by the graphical element 62. The discrete symbols 60 are superimposed over the graphical element 62. The graphical element 62 may, for example, be a trail such as a road (FIGS. 3-6) or a board game path (FIGS. 7-8).

Generally, game play is initiated by inserting money or playing a number of credits, causing the CPU to activate a number of pay lines corresponding to the amount of money or number of credits played. In one embodiment, the player selects the number of pay lines (between one and nine) to play by pressing a “Select Lines” key 50 on the video display 12. The player then chooses the number of coins or credits to bet on the selected pay lines by pressing the “Bet Per Line” key 52.

After activation of the pay lines, the reels 30-34 may be set in motion by touching the “Spin Reels” key 54 or, if the player wishes to bet the maximum amount per line, by using the “Max Bet Spin” key 56 on the video display 12. Alternatively, other mechanisms such as, for example, a lever or push button may be used to set the reels in motion. The CPU uses a random number generator to select a game outcome (e.g., “basic” game outcome) corresponding to a particular set of discrete reel “stop positions.” The CPU then causes each of the reels 30-34 to stop at the appropriate stop position. The discrete symbols 60 graphically illustrate the discrete stop positions and indicate whether the stop positions of the reels represent a winning game outcome.

Winning basic game outcomes (e.g., symbol combinations resulting in payment of coins or credits) are identifiable to the player by a pay table. In one embodiment, the pay table is affixed to the machine 10 and/or displayed by the video display 12 in response to a command by the player (e.g., by pressing the “Pay Table” button 58). A winning basic game outcome occurs when the discrete symbols 60 appearing on the reels 30-34 along an active pay line correspond to one of the winning combinations on the pay table. A winning combination, for example, could be three or more matching discrete symbols 60 along an active pay line, where the award is greater as the number of matching symbols along the active pay line increases. If the displayed discrete symbols 60 stop in a winning combination, the game credits the player an amount corresponding to the award in the pay table for that combination multiplied by the amount of credits bet on the winning pay line. The player may collect the amount of accumulated credits by pressing the “Collect” button 59. In one implementation, the winning combinations start from the first reel 30 (left to right) and span adjacent reels. In an alternative implementation, the winning combinations start from either the first reel 30 (left to right) or the fifth reel 34 (right to left) and span adjacent reels.

Included among the plurality of basic game outcomes is a start-feature outcome for triggering play of a bonus game. A start-feature outcome may be defined in any number of ways. For example, a start-feature outcome may occur when a special start-feature discrete symbol or a special combination of discrete symbols appears on one or more of the reels 30-34. The start-feature outcome may require the combination of discrete symbols to appear along an active pay line, or may alternatively require that the combination of discrete symbols appear anywhere on the display regardless of whether the discrete symbols are along an active pay line. Alternatively, any winning outcome in the basic slot game may constitute a start-feature outcome. The appearance of the appropriate start-feature outcome causes the CPU to shift operation from the basic game to the bonus game. In the embodiment illustrated in FIG. 3, a combination of two DRAGSTER symbols 60a on reels 30 and 31 and a RACING symbol 60b (e.g., two dragsters shown side by side) on reel 32 along an active pay line triggers the bonus game.

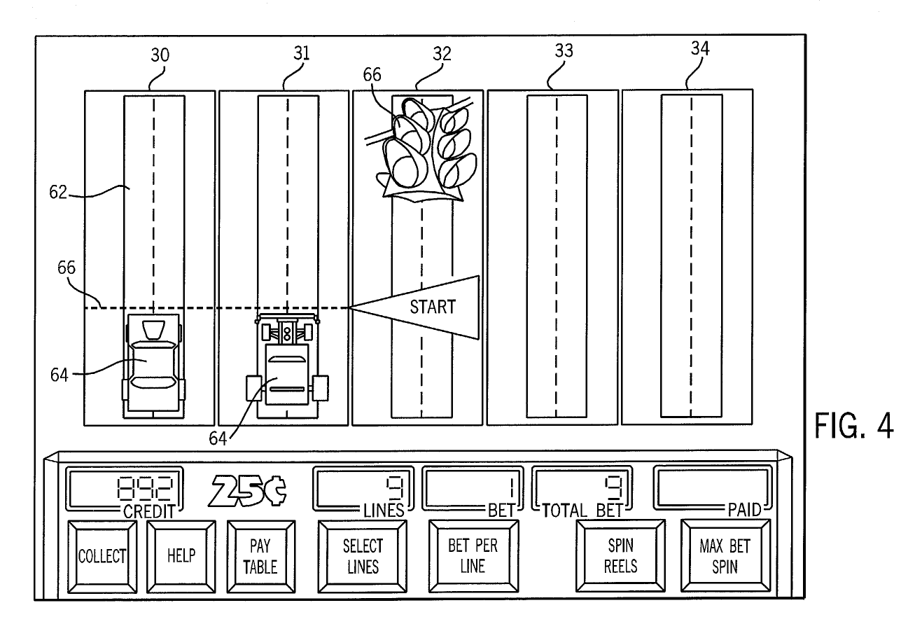

Referring to FIG. 4, at the commencement of the bonus game, the discrete symbols 60 disappear from the reels 30-34 and are replaced with a pair of dragsters 64 on the respective reels that previously included the triggering DRAGSTER symbols 60a (see FIG. 3). The pair of dragsters 64 are shown near the bottom of the respective reels behind a starting line 66. The bonus game may be interactive and, for example, prompt the player to select which dragster the player believes will win the drag race. Alternatively, the bonus game may merely depict the drag race without player interaction. The drag race starts when the stoplight 66 illuminates its green light.

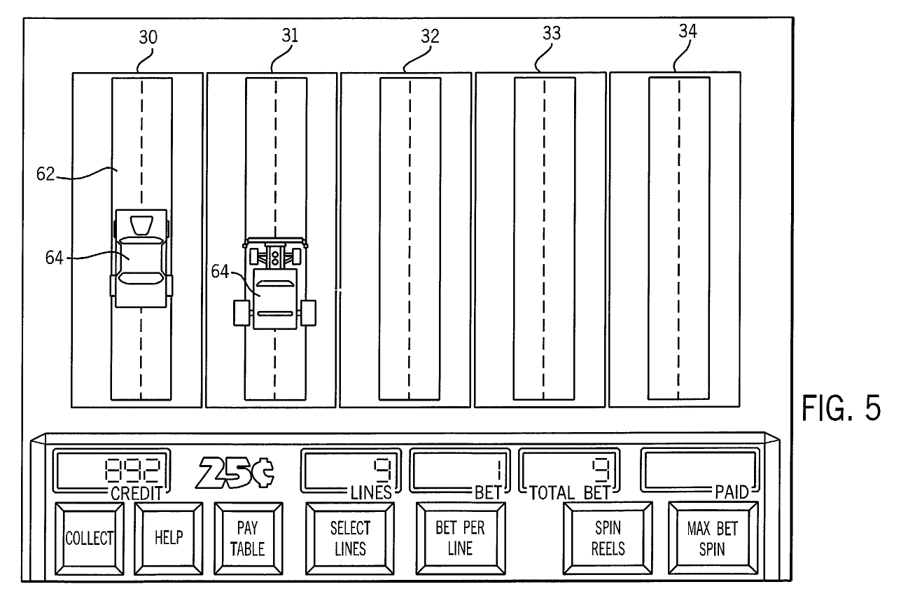

Referring to FIG. 5, during the drag race each dragster 64 moves along the continuous graphical element 62 (e.g., road), between adjacent ones of the discrete symbol positions, as the associated reel is rotated. The speed of each dragster 64 is based on the speed of rotation of the associated reel. Similarly, the distance traveled by each dragster 64 is based on the degree of rotation of the associated reel. Both dragsters 64 preferably move at similar, but slightly different, speeds such that they both remain visible on their respective reels but at horizontal positions offset from each other. In other words, the drag race is sufficiently close that both dragsters 64 appear on the video display 12 throughout the race.

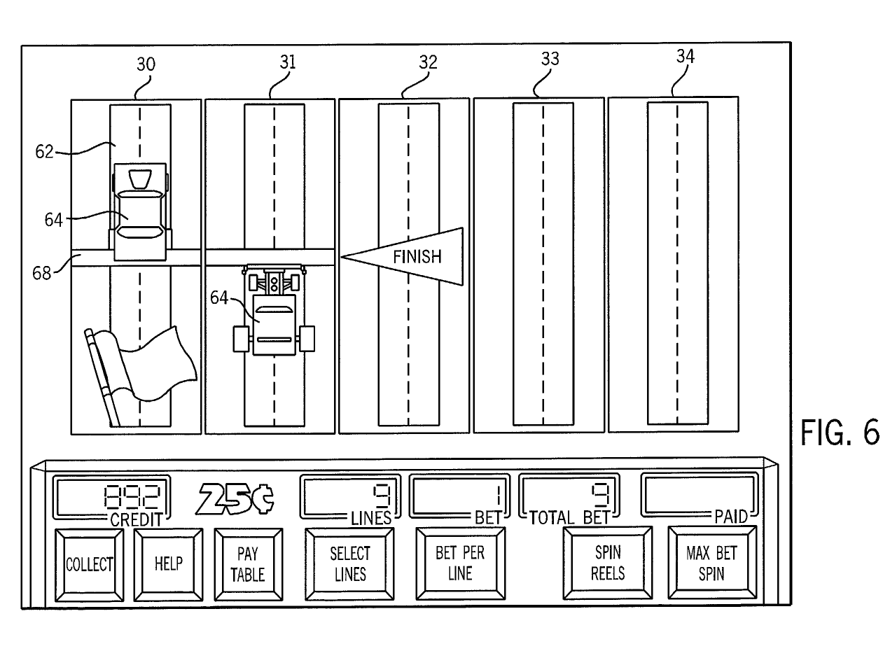

Referring to FIG. 6, as the dragsters 64 approach a finish line 68, the finish line 68 appears on the video display 12. The finish line 68 may represent movement of the dragsters 64 along the graphical element 62 for a predetermined distance (e.g., five spins of the associated reel). The bonus game ends when one of the dragsters 64 crosses the finish line 68. In the bonus game the CPU determines and awards a bonus based on the outcome of the drag race.

In one embodiment, the bonus game is essentially a double-or-nothing feature triggered by a winning outcome in the basic game. In response to a winning outcome in the basic game, a player is afforded an opportunity to double the award associated with that winning outcome by selecting which of the two dragsters 64 the player believes will win the drag race. After the player makes his or her selection, the drag race is run to determine whether the player has successfully doubled the award by making a correct selection or lost the award by making an incorrect selection. The player may be provided with the opportunity of utilizing the double-or-nothing feature several times and/or up to a certain maximum to be determined by the game operator.

In another embodiment, prior to the drag race the player selects which of the two dragsters 64 the player believes will win the drag race. The CPU awards a first prize bonus if the selected dragster wins the race, and a consolation bonus if the selected dragster loses the race. The first prize bonus may, for example, be the consolation bonus multiplied by a multiplier such as two, three, four, etc. The awarded bonus may also depend upon such factors as the amount of time taken by the selected dragster to finish the race and/or the distance by which the selected dragster wins or loses the race. The video display 12 may include a timer for each dragster 64 depicting the amount of time elapsed from the start of the drag race.

While the present invention has been described with reference to one or more particular embodiments, those skilled in the art will recognize that many changes may be made thereto without departing from the spirit and scope of the present invention.

For example, FIG. 7 depicts an alternative embodiment of the bonus game based on a Monopoly™ theme. At the commencement of the bonus game, each reel includes a continuous graphical element 70 formed by a plurality of spaces generally representative of a Monopoly board. The plurality of spaces on a reel may include such traditional spaces as color-coded properties, railroads, utilities, Community Chest, Chance, etc., as well as non-traditional spaces suited to the token 72 moving on that reel. In addition to the continuous graphical element 70, tokens 72 initially occupy the bottom of the respective reels 30-34. The bonus game may be interactive and, for example, prompt the player to select which token the player believes will win the token race. Alternatively, the bonus game may merely depict the token race without player interaction. The token race begins after the player makes any necessary selections.

Referring to FIG. 8, during the token race each token 72 moves along the continuous graphical element 70 (e.g., Monopoly board path), between adjacent ones of the discrete Monopoly board spaces, as the associated reel is rotated. For each space moved by a token 72 on its reel, the bonus for that reel is incremented by a predetermined amount such as five credits. Bonus meters 74 are shown above the respective reels 30-34. Each token 72 moves until it reaches a “stopper” space on its reel. A “stopper” space on a reel may, for example, be a traditional adverse space such as Luxury Tax or Income Tax or a non-traditional adverse space suited to the token on that reel. In FIG. 8, for example, the car token 72a on reel 30 stops at a “stop sign” space; the dog token 72b on reel 31 stops at a “fire hydrant” space; the horse token 72d on reel 33 stops at a “gate” space; and the boot token 72e on reel 34 stops at a Luxury Tax space. Because the hat token 72c on reel 32 has not yet reached a “stopper” space, the hat token 72c will win the token race.

At the completion of the token race, the CPU determines and awards a bonus based on the outcome of the token race. In one embodiment, the CPU awards the bonus on the bonus meter associated with the token selected by the player to win the token race. Therefore, if the player had selected the car token to win the token race in FIGS. 7 and 8, the CPU would award 75 credits to the player. In another embodiment, if the selected token wins the token race, the CPU awards the bonuses associated with all the tokens, not only the selected token.

Each of these embodiments and obvious variations thereof is contemplated as falling within the spirit and scope of the claimed invention, which is set forth in the following claims.

What is claimed is:

1. A slot machine comprising a rotatable reel, the reel bearing a plurality of discrete symbols and a continuous graphical element extending between adjacent ones of the discrete symbols such that the discrete symbols are unified by the graphical element.

2. The slot machine of claim 1, further including means for rotating and stopping the reel to place the discrete symbols on the reel in visual association with a display area.

3. The slot machine of claim 2, further including means for determining a payout based, at least in part, on the discrete symbols associated with the display area.

4. The slot machine of claim 1, wherein the discrete symbols are superimposed over the graphical element.

5. The slot machine of claim 1, wherein the graphical element includes a trail.

6. The slot machine of claim 5, wherein the trail is selected from a group consisting of a road and a board game path.

7. The slot machine of claim 1, wherein the reel is simulated on a video display.

8. The slot machine of claim 1, wherein the reel is physical and driven by a stepper motor.

9. A slot machine comprising a rotatable reel, the reel bearing a plurality of discrete symbol positions and a continuous graphical element extending between adjacent ones of the discrete symbol positions such that the discrete symbol positions are unified by the graphical element, the reel also bearing a discrete symbol moving between the adjacent ones of the discrete symbol positions as the reel is rotated.

10. The slot machine of claim 9, further including means for rotating and stopping the reel to place a portion of the reel in visual association with a display area.

11. The slot machine of claim 9, wherein the discrete symbol is superimposed over the graphical element.

12. The slot machine of claim 9, wherein the graphical element includes a trail.

13. The slot machine of claim 12, wherein the trail is selected from a group consisting of a road and a board game path.

14. The slot machine of claim 9, wherein the reel is simulated on a video display.

15. The slot machine of claim 9, wherein the reel is physical and driven by a stepper motor.

16. The slot machine of claim 9, further including means for determining a payout based on movement of the discrete symbol between the adjacent ones of the discrete symbol positions as the reel is rotated.

17. The slot machine of claim 16, wherein the payout accumulates based on each discrete symbol position traversed by the discrete symbol.

18. A method of conducting a slot game on a slot machine controlled by a processor, comprising:
receiving a wager from a player; and
rotating and stopping a reel to place a portion of the reel in visual association with a display area, the reel bearing a plurality of discrete symbols and a continuous graphical element extending between adjacent ones of the discrete symbols such that the discrete symbols are unified by the graphical element.

19. The method of claim 18, wherein the discrete symbols are superimposed over the graphical element.

20. The method of claim 18, wherein the graphical element includes a trail.

21. The method of claim 20, wherein the trail is selected from a group consisting of a road and a board game path.

22. The method of claim 18, wherein the reel is simulated on a video display.

23. The method of claim 18, wherein the reel is physical and driven by a stepper motor.

24. The method of claim 18, further including determining a payout based, at least in part, on the portion of the reel associated with the display area.

25. A method of conducting a slot game on a slot machine controlled by a processor, comprising:
receiving a wager from a player;
rotating a reel bearing a plurality of discrete symbol positions and a continuous graphical element extending between adjacent ones of the discrete symbol positions such that the discrete symbol positions are unified by the graphical element; and
moving a discrete symbol between the adjacent ones of the discrete symbol positions as the reel is rotated.

26. The method of claim 25, further including stopping the reel to place a portion of the reel in visual association with a display area.

27. The method of claim 25, wherein the discrete symbol is superimposed over the graphical element.

28. The method of claim 25, wherein the graphical element includes a trail.

29. The method of claim 28, wherein the trail is selected from a group consisting of a road and a board game path.

30. The method of claim 25, wherein the reel is simulated on a video display.

31. The method of claim 25, wherein the reel is physical and driven by a stepper motor.

32. The method of claim 25, further including determining a payout based on movement of the discrete symbol between the adjacent ones of the discrete symbol positions as the reel is rotated.

33. The method of claim 32, wherein the payout accumulates based on each discrete symbol position traversed by the discrete symbol.
